(19) United States
(12) Patent Application Publication
(10) Pub. No.: US 2006/0209200 A1
(43) Pub. Date: Sep. 21, 2006

(54) Frequency modulation technique for CMOS image sensors

(75) Inventor: Weize Xu, Rochester, NY (US)

Correspondence Address: Pamela R. Crocker;Eastman Kodak Company, Patent Legal Staff, 343 State Street, Rochester, NY, 14650-2201, US

(73) Assignee: Eastman Kodak Company

(21) Appl. No.: 11/080,123

(22) Filed: Mar. 15, 2005

(51) Int. Cl. H04N 5/335

(52) U.S. Cl. 348/294

(57) ABSTRACT

An image sensor includes a plurality of photo-sensitive elements arranged in an array in which each photo-sensitive element converts incident light into a charge packet; a charge-to-voltage converter that receives each charge packet and converts the charge packet into a voltage; a voltage-to-frequency converter that receives each voltage and converts the voltage into a signal having a frequency; and a frequency-to-digital signal converter that receives each signal having the frequency and converts the signal having the frequency into a digital signal.

### FIELD OF THE INVENTION

The invention relates generally to the field of CMOS image sensors. More specifically, the invention relates to such image sensors that process signals from the analog domain to the frequency domain and then to the digital domain.

### BACKGROUND OF THE INVENTION

With the performance improved rapidly, CMOS image sensors are increasingly found in more and more applications. Currently, CMOS image sensor circuits all have substantially the same structure. There is typically a photo sensitive device, like photodiodes, in the pixel array that convert the optical signal into an electric signal, which are stored by a sample/hold circuit (or a circuit array). In this manner, an analog signal processing chain is placed before an analog-to-digital converter.

Although the present image sensor design is satisfactory, improvements are desirable. One shortcoming of the present CMOS image sensor is that the analog processing chain includes high noise, low speed and high power.

Consequently, a need exists for an improved design in which the analog-to-digital conversion is placed at earlier stages of the processing and process signal in the digital domain. Therefore, in this invention, the analog signals are converted into digital codes immediately at the pixel array outputs by using a frequency modulation technique.

### SUMMARY OF THE INVENTION

The present invention is directed to overcoming one or more of the problems set forth above. Briefly summarized, according to one aspect of the present invention, the present invention resides in an image sensor comprising (a) a plurality of photo-sensitive elements arranged in an array in which each photo-sensitive element converts incident light into a charge packet; (b) a charge-to-voltage converter that receives each charge packet and converts the charge packet into a voltage; (c) a voltage-to-frequency converter that receives each voltage and converts the voltage into a signal having a frequency; and (d) a frequency-to-digital signal converter that receives each signal having a frequency and converts the signal having the frequency into a digital signal.

The above and other objects of the present invention will become more apparent when taken in conjunction with the following description and drawings wherein identical reference numerals have been used, where possible, to designate identical elements that are common to the figures.

### ADVANTAGEOUS EFFECT OF THE INVENTION

The present invention has the advantage of high-speed processing and low noise.

### BRIEF DESCRIPTION OF THE DRAWINGS

FIG. 1 is a schematic diagram of a typical pixel of the present invention; and

FIG. 2 is a block diagram of the present invention.

### DETAILED DESCRIPTION OF THE INVENTION

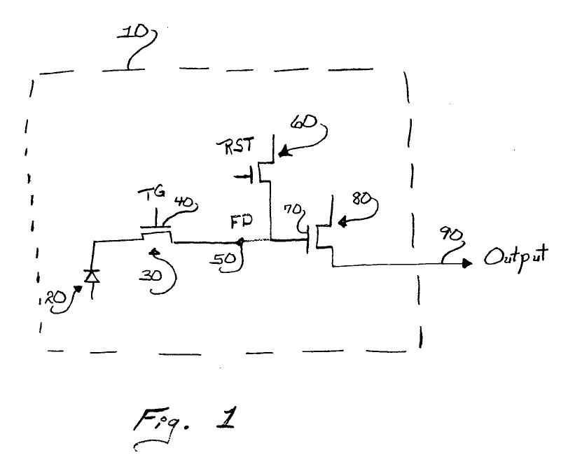

Referring to FIG. 1, there is shown a schematic diagram of a typical pixel 10 of the present invention, although, it should be noted that, other pixel configurations, such as a four-transistor configuration and the like, are possible. It is further noted that an image sensor includes a plurality of pixels 10 and only one pixel is shown in FIG. 1 for clarity of understanding. In this regard, each pixel 10 includes a photodiode or photosensitive area 20 that converts incident light into a charge. A transistor 30 is electrically connected to the photodiode 20 and includes a transfer gate 40 that, when pulsed, permits the charge to pass from the photodiode 20 to a charge-to-voltage conversion region 50, a floating diffusion in the preferred embodiment.

A reset transistor 60 is electrically connected to the node of the floating diffusion 50 for resetting the voltage of the floating diffusion 50. A gate 70 of an amplifying transistor 80 is electrically connected to the floating diffusion 50 for receiving and amplifying the voltage of the floating diffusion 50. The amplifying transistor 80 receives and transfers the image signal captured by the pixels 10 to the output 90. It is noted that each pixel a row is connected via the output 90 to a row select bus (not shown) that enables the selection of a particular row for read out.

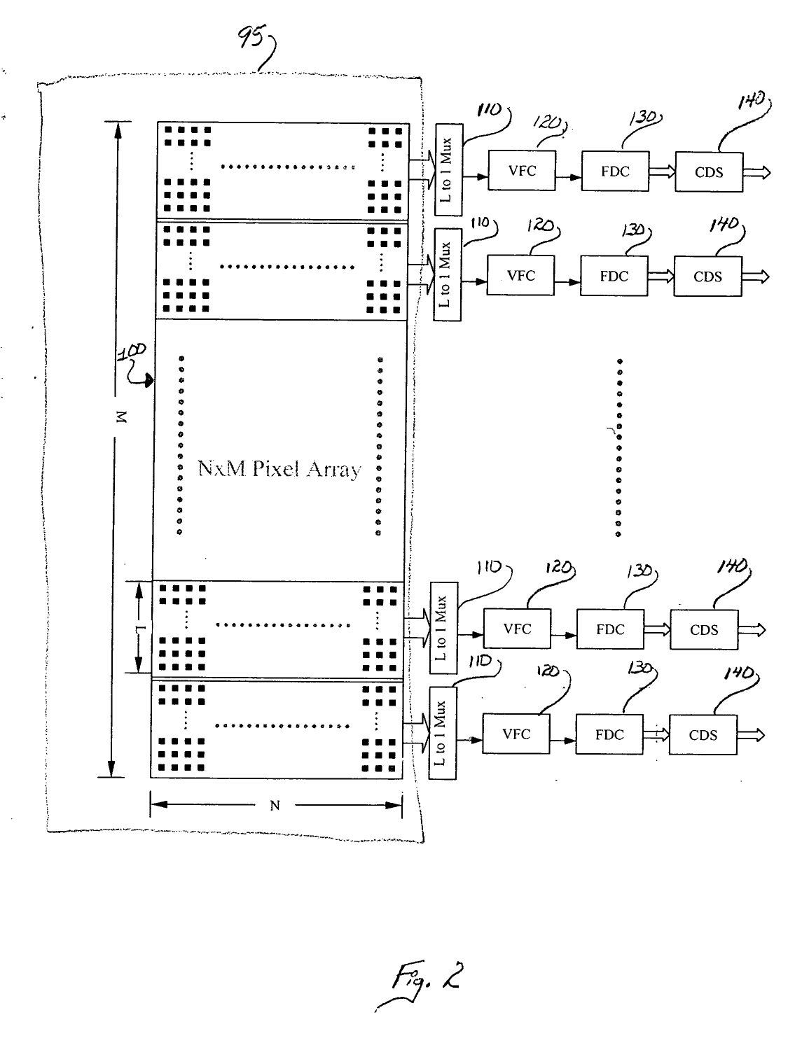

Referring to FIG. 2, there is shown a block diagram of the present invention. An image sensor 95 includes a pixel array 100 having a plurality of pixels 10 as described hereinabove that captures an electronic representation of a scene. A plurality of multiplexers 110 is connected to a predefined number of pixel rows for selecting one of the predefined number of rows and reading out the selected row. Each multiplexer 110 is respectively connected to a voltage-to-frequency converter 120 for converting the voltage received from each pixel 10 of the selected row into an analog signal having a frequency corresponding to the incoming voltage. For example, a voltage of 1 volt may be converted to a frequency of 1 hertz and 2 volts may have a frequency of 2 hertz. A frequency-to-digital signal converter 130 is respectively connected to each voltage-to-frequency converter 120 for converting the received frequency from the voltage-to-frequency converter 120 to a digitized code. For example, a frequency of 1 hertz may have a digital value of 001 and a frequency of 2 hertz may have a digital value of 011. A correlated double sampling circuit 140 is respectively connected to each frequency-to-digital signal converter 130, which correlated double sampling circuit 140 receives the digitized values for reducing noise in the digitized signal. The digital signal is then passed to other circuits for further processing, if necessary, and subsequent storage.

The invention has been described with reference to a preferred embodiment. However, it will be appreciated that variations and modifications can be effected by a person of ordinary skill in the art without departing from the scope of the invention.

### PARTS LIST

10 pixel
20 photodiode or photosensitive area
30 transistor
40 transfer gate
50 floating diffusion
60 reset transistor
70 gate of an amplifier transistor
80 amplifying transistor
90 output
95 image sensor
100 pixel array
110 multiplexer
120 voltage-to-frequency converter
130 frequency-to-digital signal converter
140 correlated double sampling circuit

1. An image sensor comprising:
(a) a plurality of photo-sensitive elements arranged in an array in which each photo-sensitive element converts incident light into a charge packet;
(b) a charge-to-voltage converter that receives each charge packet and converts the charge packet into a voltage;
(c) a voltage-to-frequency converter that receives each voltage and converts the voltage into a signal having a frequency; and
(d) a frequency-to-digital signal converter that receives each signal having a frequency and converts the signal having the frequency into a digital signal.

2. The image sensor as in claim 1 further comprising a plurality of voltage-to-frequency converters each receiving charge packets from a predefined number of photo-sensitive elements that receives the voltages and converts the voltages into signals having a frequency.

3. The image sensor as in claim 2 further comprising a plurality of frequency-to-digital signal converters each respectively connected to a voltage-to-frequency converter.

4. The image sensor as in claim 3 further comprising a multiplexer that selects a predefined number of voltages associated with the photo-sensitive elements and that passes each voltage to one of the voltage-to-frequency converters.

5. The image sensor as in claim 4 further comprising a plurality of correlated double sampling circuits each respectively connected to a frequency-to-digital signal converter for reducing noise.

6. The image sensor as in claim 1, wherein the image sensor is a CMOS image sensor.

7. A method for processing a signal from an image sensor, the method comprising the steps of:
(a) converting incident light into a charge packet;
(b) converting the charge packet into a voltage;
(c) converting the voltage into a signal having a frequency; and
(d) converting the signal having the frequency into a digital signal.
